(19) United States
(12) Patent Application Publication
(10) Pub. No.: US 2004/0111736 A1
(43) Pub. Date: Jun. 10, 2004

(54) Optical pickup apparatus

(75) Inventor: Takehiro Matsuda, Saitama (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/665,363

(22) Filed: Sep. 22, 2003

(30) Foreign Application Priority Data
Sep. 20, 2002 (JP) P2002-274723

(51) Int. Cl. G11B 7/08; G11B 7/085; G11B 7/09

(52) U.S. Cl. 720/683

(57) ABSTRACT

An actuator includes an intervention member being interposed between an object lens and a bobbin for supporting the object lens and different from the bobbin in thermal conductivity, thereby preventing an occurrence of degradation of the lens characteristic of the object lens caused by unevenness of the temperature distribution in the object lens due to the heat generated by a coil.

The present disclosure relates to the subject matter contained in Japanese Patent Application No. 2002-274723 filed on Sep. 20, 2002, which is incorporated herein by reference in its entirety.

### BACKGROUND OF THE INVENTION

1. Field of the Invention

The present invention relates to an optical pickup apparatus for playing back information recorded on an optical disk.

2. Description of the Related Art

A pickup apparatus for playing back information recorded on an optical disk such as a CD or a DVD is known. The pickup apparatus is an apparatus for applying a laser beam of a predetermined wavelength to an optical disk through an object lens and receiving the laser beam reflected on the optical disk at a light reception element, thereby reading information written onto the optical disk.

The pickup apparatus performs focusing control of controlling the distance between the information record side of the optical disk and the object lens against warpage or runout of the optical disk and also performs tracking control of the object lens relative to the eccentricity of an information track of the optical disk. Accordingly, the laser beam is applied onto any desired track and the information recorded on the optical disk is read precisely.

An actuator for performing the focusing control and the tracking control has a moving section, which is made up of the object lens, a bobbin for supporting the object lens, a plurality of coils placed on the bobbin, a linear elastic member for holding the bobbin movably, and the like. A proper amount of electric current is provided into each coil. The object lens is displaced together with the bobbin in the focus or tracking direction for a minute amount by the interaction between the electric current flowing through the coil and the magnetic field formed in the proximity of the coil, and the focus control or the tracking control is performed. Generally, the actuator is optimally designed considering enhancement of sensitivity, a decrease in dynamic tilt of the lens, and suppression of unnecessary resonance.

However, when a current is provided to the coil, the coil generates heat and the heat is transferred through the bobbin to the object lens. The heat transferred to the object lens makes an uneven temperature distribution in the object lens, causing the refractive index of the object lens to be varied from one point to another. Accordingly, the lens characteristic of the whole object lens (particularly, astigmatism aberration) becomes deteriorated and it becomes difficult to precisely read information on the disk. The above problem becomes noticeable particularly when a lens made of a material having physical property value that largely changes by heat (e.g. plastic), is used.

The effect of occurrence of the astigmatism aberration on a detection signal from the optical disk increases as the optical disk becomes a higher density and is turned at higher speed, degrading the detection signal remarkably. Therefore, unevenness of the temperature distribution cannot be ignored to intend to provide higher density and speed of optical disk expected in the future.

### SUMMARY OF THE INVENTION

The invention was made in view of such a conventional circumference and an object of the invention is to solve a problem of degradation of the lens characteristic of an object lens caused by unevenness of the temperature distribution in the object lens.

In order to achieve the object, according to a first aspect of the invention, there is provided an optical pickup apparatus including: an object lens arranged to be opposed to an optical disk; a bobbin configured to support the object lens; and an intervention member being interposed between the object lens and the bobbin and is different from the bobbin in thermal conductivity.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view to show a pickup apparatus of a first embodiment according to the invention;

FIG. 2 is an enlarged perspective view of an actuator of the pickup apparatus;

FIG. 3 is an exploded perspective view of the actuator of the pickup apparatus;

FIG. 4 is a perspective view of an actuator moving section of the first embodiment;

FIG. 5 is a sectional view of the actuator moving section of the first embodiment;

FIG. 6 is a perspective view of an actuator moving section of a second embodiment according to the invention;

FIG. 7 is a sectional view of the actuator moving section of the second embodiment;

FIG. 8 is a perspective view of an actuator moving section of a third embodiment according to the invention;

FIG. 9 is a sectional view of the actuator moving section of the third embodiment;

FIG. 10 is a sectional view of an actuator moving section of a fourth embodiment according to the invention; and

FIG. 11 is a sectional view of an actuator moving section of a fifth embodiment according to the invention.

### DETAILED DESCRIPTION OF THE PREFERRED EMBODIMENTS

Referring now to the accompanying drawings, there are shown preferred embodiments of the invention.

First Embodiment

A pickup apparatus 1 of a first embodiment according to the invention will be discussed below with reference to the accompanying drawings.

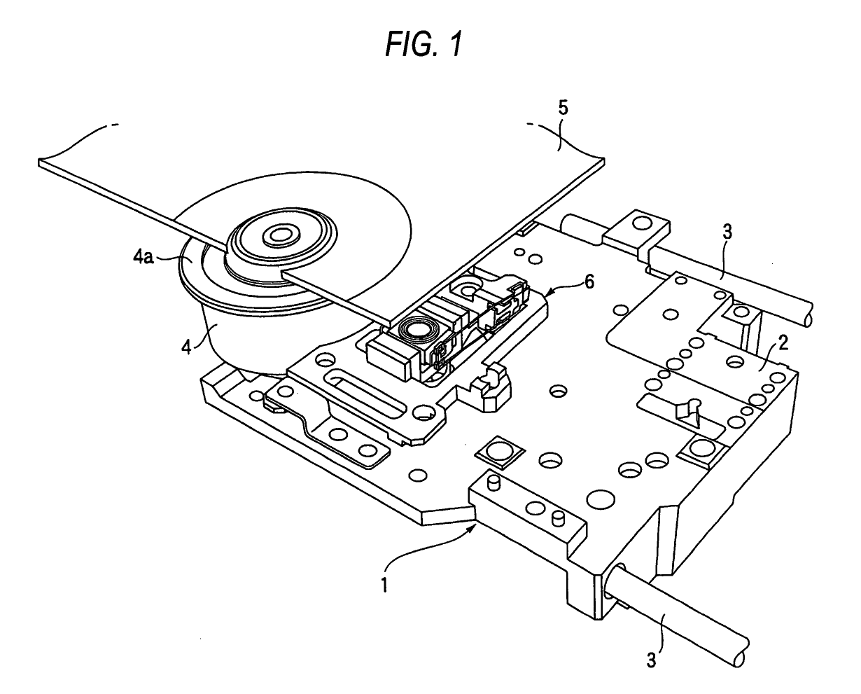

FIG. 1 is a perspective view to show the pickup apparatus 1 of the first embodiment according to the invention. The pickup apparatus 1 is placed in an optical disk unit of optical disk apparatus such as a CD player and a DVD player. The pickup apparatus 1 includes a pickup body 2 placed movably on guide shafts 3 and 3 and an actuator 6 placed fixedly on the pickup body 2. The pickup apparatus 1 is opposed to the record side of an optical disk 5 placed on a disk placement section 4a that can be turned through a spindle 4.

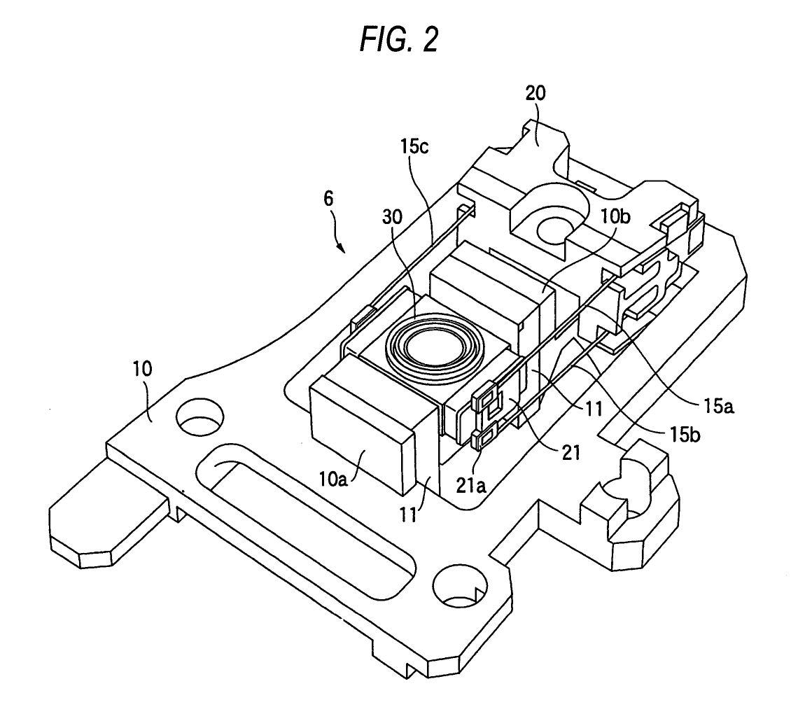

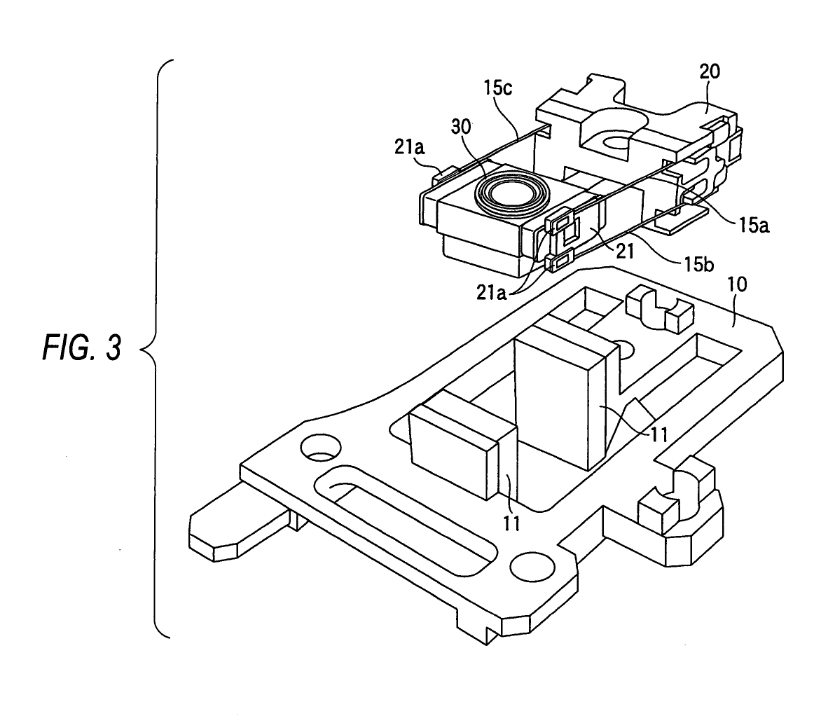

FIG. 2 is an enlarged perspective view of the actuator 6. FIG. 3 is an exploded perspective view of the actuator 6. The actuator 6 has a yoke 10, an actuator fixing section 20, and an actuator moving section 30 that can be very little displaced relative to the yoke 10 and the actuator fixing section 20. Attachment members 21 are fixed to sides of the actuator moving section 30. Four longitudinal elastic members 15a to 15d are attached to attachment sections 21a of the attachment members 21. The actuator moving section 30 is supported on the actuator fixing section 20 by the longitudinal elastic members 15a to 15d.

A pair of magnet members 11 is opposed to each other on the yoke 10 along the disk circumferential direction so as to sandwich the actuator moving section 30 between the magnet members 11.

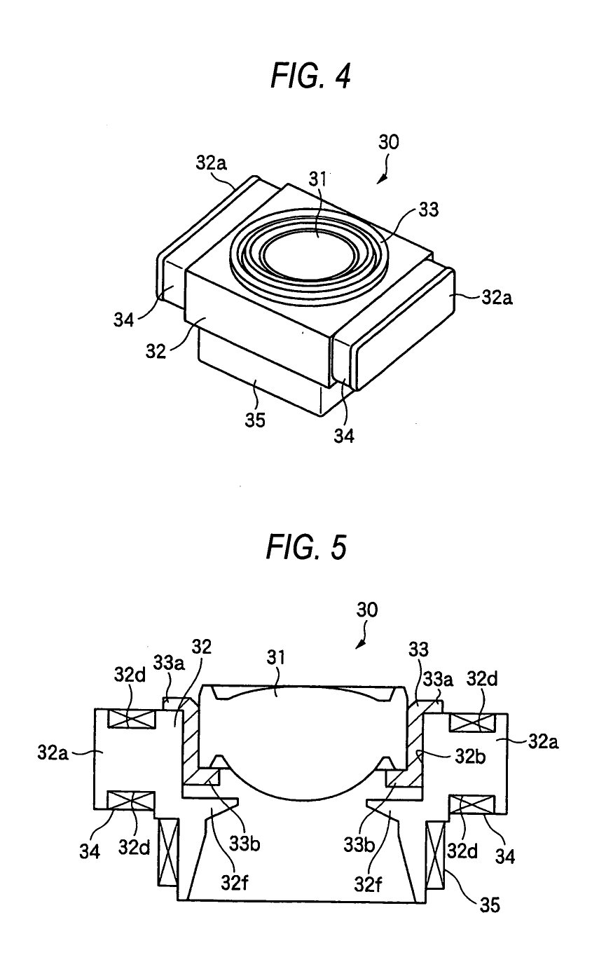

FIG. 4 is a perspective view of the actuator moving section 30 of the embodiment. FIG. 5 is a sectional view of the actuator moving section 30. The actuator moving section 30 includes an object lens 31, a bobbin 32, an intervention member 33, a pair of tracking coils 34, and a focus coil 35.

The bobbin 32 is a resin member having tracking coil retention sections 32a for winding the tracking coils therearound on opposed sides and containing a lens storing hole 32b shaped like a cylinder pierced up and down in the axial direction. The bobbin 32 is formed with an iris section 32f projected from the peripheral surface of the lens storing hole 32b to the radial inside. The iris section 32f matches the diameter of laser light incident on the object lens 31 with the effective diameter of the object lens 31. The intervention member 33 is inserted into the top of the inner peripheral surface of the lens storing hole 32b and is placed on the inner peripheral surface of the lens storing hole 32b in an intimate contact manner.

The intervention member 33 is a cylindrical-shaped member having the same shape as the inner peripheral surface of the lens storing hole 32b. The intervention member 33 is formed at one end in the axial direction with a flange 33a bent to the outer diameter side. The flange 33a of the intervention member 33 is placed on a top face 32c of the bobbin 32 in an intimate contact manner. The intervention member 33 is formed at an opposite end in the axial direction with a flange 33b bent to the inner peripheral side. The intervention member 33 is formed of a material having higher thermal conductivity than the resin bobbin 32. The object lens 31 is inserted into the inner peripheral side of the intervention member 33 and is fixed onto the inner peripheral surface and the flange 33b of the intervention member 33 in an intimate contact manner.

The object lens 31 is a lens having a circular shape on the top view. It narrows down light of a predetermined wavelength emitted from a light source (not shown) positioned below the bobbin 32 and applies the light along the track formed on the information record side of the optical disk 5. The object lens 31 allows the light reflected on the information record side of the optical disk 5 to pass through and sends the light to a light reception section having a light reception element (not shown). The object lens 31 is fixed onto the bobbin 32 through the intervention member 33 and is not in direct contact with the bobbin 32.

A pair of tracking coil retention sections 32a are projected from both sides of the bobbin 32 in the tracking direction. Each tracking coil retention section 32a is formed on a side with a tracking coil retention groove 32d and each tracking coil 34, 34 is wound along the tracking coil retention groove 32d.

The tracking coils 34 are coils for moving the actuator moving section 30 in the tracking direction. The disk circumferential components of the tracking coils 34 are opposed to the magnet members 11 placed in front and in rear. The magnetic field formed by each magnet member 11 is made almost vertical to the wiring direction of the coil.

When a current is provided to the tracking coil 34, 34, a force for trying to move the actuator moving section 30 in the tracking direction acts by the interaction between the magnetic field formed by each magnet member 11 and the current in the tracking coil 34, 34. The force changes with the direction of the current flowing through the tracking coil 34, 34. Therefore, as the direction of the current flowing through the tracking coil 34, 34 is changed, the actuator moving section 30 swings in the tracking direction.

On the sides of the bobbin 32, the focus coil 35 is wound in the rotation direction around the optical axis of the object lens 31. The focus coil 35 is a coil for moving the actuator moving section 30 in the focus direction. The disk radial component of the focus coil 35 is opposed to the magnet members 11 placed in front and in rear. The magnetic field formed by each magnet member 11 is made almost vertical to the wiring direction of the coil.

When a current is provided to the focus coil 35, a force for trying to move the actuator moving section 30 in the focus direction acts by the interaction between the magnetic field formed by each magnet member 11 and the current in the focus coil 35. The force changes with the direction of the current flowing through the focus coil 35. Therefore, as the direction of the current flowing through the focus coil 35 is changed, the actuator moving section 30 swings in the focus direction.

The tracking coils 34 and the focus coil 35 generate heat as current flows. The heat is conducted asymmetrically to the intervention member 33 in response to the position of each coil placed on the bobbin 32. The intervention member 33 is formed of a material having higher thermal conductivity than the resin bobbin 32 and thus rapidly conducts the asymmetrically conducted heat in the circumferential direction of the intervention member 33 and conducts the heat uniformly from the perimeter of the object lens 31 to the object lens 31. Therefore, the temperature distribution in the object lens 31 becomes almost concentric and unevenness on the concentric circumference of the temperature distribution occurring in the object lens 31 is remarkably relieved. Thus, degradation of the lens characteristic of the object lens 31 is suppressed and the detection reliability of a detection signal is enhanced.

The material of the intervention member 33 may be any material having higher thermal conductivity than the resin bobbin 32; preferably, having thermal conductivity twice or more as high as that of the resin bobbin 32. The intervention member 33 is a component of the actuator moving section 30 and thus preferably is lightweight to such an extent that it does not degrade the sensitivity of the actuator.

As described above, according to the pickup apparatus 1 of the embodiment, the object lens 31 is fixed onto the bobbin 32 through the intervention member 33 having higher thermal conductivity than the resin bobbin 32. Therefore, the intervention member 33 acts so as to make an asymmetrical temperature distribution in the bobbin 32 uniform in the circumferential direction of the object lens 31. Accordingly, the circumferential temperature distribution in the object lens 31 is made almost uniform, so that degradation of the lens characteristic of the object lens 31 is suppressed and the detection reliability of a detection signal is enhanced.

Second Embodiment

A pickup apparatus of a second embodiment according to the invention will be discussed below with reference to the accompanying drawings.

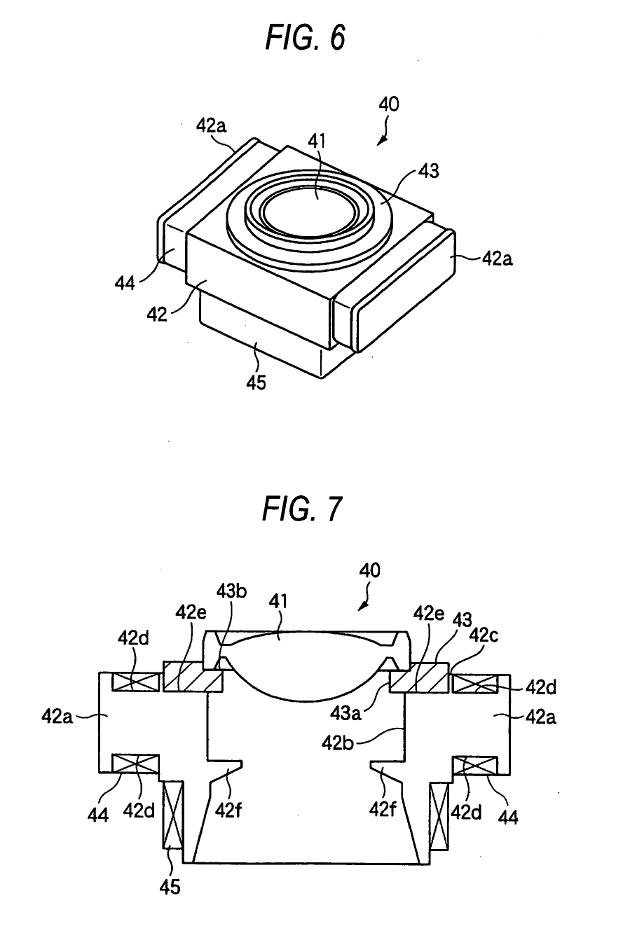

FIG. 6 is a perspective view of an actuator moving section 40 of the embodiment, and FIG. 7 is a sectional view of the actuator moving section 40. The actuator moving section 40 includes an object lens 41, a bobbin 42, an intervention member 43, a pair of tracking coils 44, and a focus coil 45.

The bobbin 42 is a resin member having tracking coil retention sections 42a for winding the tracking coils therearound on opposed sides and containing a through hole 42b, as a lens storing hole, shaped like a cylinder pierced up and down in the axial direction. The bobbin 42 is formed with an iris section 42f projected from the peripheral surface of the through hole 42b to the radial inside. The iris section 42f matches the diameter of laser light incident on the object lens 41 with the effective diameter of the object lens 41. The bobbin 42 is formed on a top face 42c with a step section 42e surrounding the through hole 42b. The intervention member 43 is fixed onto the step section 42e.

The intervention member 43 is a plate-like member having a circular shape on the top view. It has almost the same shape as a side of the step section 42e and is fixed along the shape of the step section 42e in an intimate contract manner. A circular through hole 43a is made in the center of the intervention member 43, and a step section 43b for placing the object lens 41 thereon is formed in the surroundings of the through hole 43a. The intervention member 43 is formed of a material having higher thermal conductivity than the resin bobbin 42.

The object lens 41 is inserted into the top of the step section 43b of the intervention member 43. The object lens 41 is a lens having a circular shape on the top view and is placed so that a convex part of the lens is positioned in the through hole 43a of the intervention member 43. The object lens 41 narrows down light of a predetermined wavelength emitted from a light source (not shown) positioned below the bobbin 42 and applies the light along the track formed on the information record side of an optical disk 5. The object lens 41 allows the light reflected on the information record side of the optical disk 5 to pass through and sends the light to a light reception section having a light reception element (not shown). The object lens 41 is fixed onto the bobbin 42 through the intervention member 43 and is not in direct contact with the bobbin 42.

A pair of tracking coil retention sections 42a is projected from both sides of the bobbin 42 in the tracking direction. Each tracking coil retention section 42a is formed on a side with a tracking coil retention groove 42d and each tracking coil 44, 44 is wound along the tracking coil retention groove 42d. The configuration of placement and the function of the tracking coils 44 are the same as those of the tracking coils 34 of the first embodiment.

On the sides of the bobbin 42, the focus coil 45 is wound in the rotation direction around the optical axis of the object lens 41. The focus coil 45 is a coil for moving the actuator moving section 40 in the focus direction. The configuration of placement and the function of the focus coil 45 is the same as those of the focus coil 35 of the first embodiment.

The tracking coils 44 and the focus coil 45 generate heat as current flows. The heat is conducted asymmetrically to the intervention member 43 in response to the position of each coil placed on the bobbin 42. The intervention member 43 is formed of a material having higher thermal conductivity than the resin bobbin 42 and thus rapidly conducts the asymmetrically conducted heat in the circumferential direction of the intervention member 43 and conducts the heat uniformly from the perimeter of the object lens 41 to the object lens 41. Therefore, the temperature distribution in the object lens 41 becomes almost concentric and unevenness on the concentric circumference of the temperature distribution occurring in the object lens 41 is remarkably relieved. Thus, degradation of the lens characteristic of the object lens 41 is suppressed and the detection reliability of a detection signal is enhanced.

As described above, according to the embodiment, the object lens 41 is fixed onto the bobbin 42 through the intervention member 43 having higher thermal conductivity than the resin bobbin 42. Therefore, the intervention member 43 acts so as to make an asymmetrical temperature distribution in the bobbin 42 uniform in the circumferential direction of the object lens 41. Accordingly, the circumferential temperature distribution in the object lens 41 is made almost uniform, so that degradation of the lens characteristic of the object lens 41 is suppressed and the detection reliability of a detection signal is enhanced.

Third Embodiment

A pickup apparatus of a third embodiment according to the invention will be discussed below with reference to the accompanying drawings.

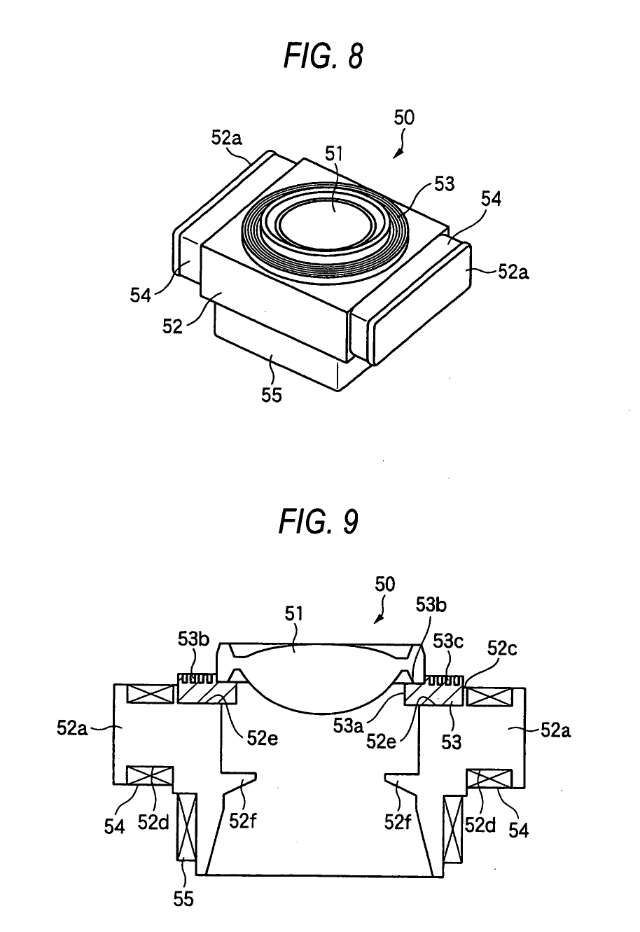

FIG. 8 is a perspective view of an actuator moving section 50 of the embodiment, and FIG. 9 is a sectional view of the actuator moving section 50. The actuator moving section 50 includes an object lens 51, a bobbin 52, an intervention member 53, a pair of tracking coils 54, and a focus coil 55.

The actuator moving section 50 of the embodiment differs from the actuator moving section 40 of the second embodiment only in that the intervention member 53 is improvement in the intervention member 43; other components 51, 52, 54, and 55 are identical with the components 41, 42, 44, and 45 of the second embodiment.

The intervention member 53 of the third embodiment is a plate-like member having a circular shape on the top view. It has almost the same shape as a side of a step section 52e of the bobbin 52 and is fixed along the shape of the step section 52e in an intimate contract manner. A circular through hole 53a is made in the center of the intervention member 53, and a step section 53b for placing the object lens 51 thereon is formed in the surroundings of the through hole 53a. The intervention member 53 is formed of a material having higher thermal conductivity than the resin bobbin 52.

The intervention member 53 is formed on the top face with a plurality of grooves 53c concentrically along the circumferential direction. These grooves 53c increase the surface area of the intervention member 53 and function as a radiating fin of a heat sink for dissipating the heat conducted to the intervention member 53 to the outside. The intervention member 53 fixes the object lens 51 so that the object lens 51 and the bobbin 52 do not come in direct contact with each other.

The tracking coils 54 and the focus coil 55 generate heat as current flows. The heat is conducted asymmetrically to the intervention member 53 in response to the position of each coil placed on the bobbin 52. The intervention member 53 is formed of a material having higher thermal conductivity than the resin bobbin 52 and thus rapidly conducts the asymmetrically conducted heat in the circumferential direction of the intervention member 53. Thus, the circumferential temperature of the intervention member 53 becomes almost uniform and the heat is conducted uniformly from the perimeter of the object lens 51 to the object lens 51. Therefore, the temperature distribution in the object lens 51 becomes almost concentric and unevenness on the concentric circumference of the temperature distribution occurring in the object lens 51 is remarkably relieved. Thus, degradation of the lens characteristic of the object lens 51 is suppressed and the detection reliability of a detection signal is enhanced.

Further, as the surface area coming in contact with the outside air increases in the presence of the grooves 53c formed on the top face of the intervention member 53, the heat conducted to the intervention member 53 is dissipated to the outside for aggressively decreasing the amount of heat flowing into the object lens 51. Therefore, a temperature rise in the object lens 51 is suppressed, so that degradation of the lens characteristic of the object lens 51 is suppressed. Accordingly, the reliability of a signal detected through the object lens 51 is enhanced.

As described above, according to the embodiment, the object lens 51 is fixed onto the bobbin 52 through the intervention member 53 having higher thermal conductivity than the resin bobbin 52. Therefore, the intervention member 53 acts so as to make an asymmetrical temperature distribution in the bobbin 52 uniform in the circumferential direction of the object lens 51. The grooves 53c formed on the intervention member 53 dissipate the heat conducted to the intervention member 53 to the outside for aggressively decreasing the amount of heat flowing into the object lens 51. Accordingly, the circumferential temperature distribution in the object lens 51 is made almost uniform and the amount of heat flowing into the object lens 51 is decreased, so that degradation of the lens characteristic of the object lens 51 is suppressed and the detection reliability of a detection signal is enhanced.

Fourth Embodiment

A pickup apparatus of a fourth embodiment according to the invention will be discussed below with reference to the accompanying drawing.

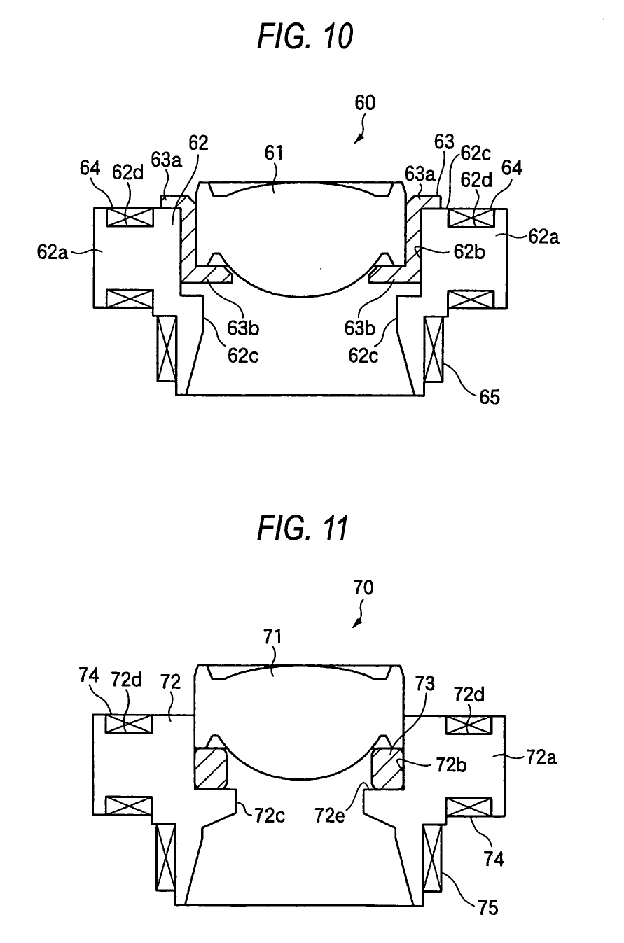

FIG. 10 is a perspective view of an actuator moving section 60 of the fourth embodiment. The actuator moving section 60 includes an object lens 61, a bobbin 62, an intervention member 63, a pair of tracking coils 64, and a focus coil 65.

The actuator moving section 60 of the embodiment has the intervention member 63 functioning as an iris section in place of the iris section 32f formed in the bobbin 32 of the actuator moving section 30 of the first embodiment. Other components are identical with those of the first embodiment.

The intervention member 63 is a cylindrical-shaped member having the same shape as the inner peripheral surface of a lens storing hole 62b. The intervention member 63 is formed at one end in the axial direction with a flange 63a bent to the outer diameter side. The flange 63a of the intervention member 63 is placed on a top face 62c of the bobbin 62 in an intimate contact manner. The intervention member 63 is formed at an opposite end in the axial direction with a flange 63b bent to the radial inside and projected. The tip of the flange 63b projects to the proximity of the surface of the object lens 61 for limiting the diameter of laser light incident on the object lens 61. This means that the flange 63b functions as an iris for matching the diameter of laser light incident on the object lens 61 with the effective diameter of the object lens 61.

The intervention member 63 is formed of a material having higher thermal conductivity than the resin bobbin 62. The object lens 61 is inserted into the inner peripheral side of the intervention member 63 and is fixed onto the inner peripheral surface and the flange 63b of the intervention member 63 in an intimate contact manner. In the embodiment, for the flange 63b to limit the diameter of laser light, the flange 63b is formed of an optically nontransparent material.

When each coil is energized, the tracking coils 64 and the focus coil 65 generate heat as current flows. The heat is conducted asymmetrically to the intervention member 63 in response to the position of each coil placed on the bobbin 62. The intervention member 63 is formed of a material having higher thermal conductivity than the resin bobbin 62 and thus rapidly conducts the asymmetrically conducted heat in the circumferential direction of the intervention member 63. Thus, the circumferential temperature of the intervention member 63 becomes almost uniform and the heat is conducted uniformly from the perimeter of the object lens 61 to the object lens 61. Therefore, the temperature distribution in the object lens 61 becomes almost concentric and unevenness on the concentric circumference of the temperature distribution occurring in the object lens 61 is remarkably relieved. Thus, degradation of the lens characteristic of the object lens 61 is suppressed and the detection reliability of a detection signal is enhanced.

As described above, according to the embodiment, the object lens 61 is fixed onto the bobbin 62 through the intervention member 63 having higher thermal conductivity than the resin bobbin 62. Therefore, the intervention member 63 acts so as to make an asymmetrical temperature distribution in the bobbin 62 uniform in the circumferential direction of the object lens 61. Accordingly, the circumferential temperature distribution in the object lens 61 is made almost uniform, degradation of the lens characteristic of the object lens 61 is suppressed, and the detection reliability of a detection signal is enhanced. Since the intervention member 63 also has the iris function, in a case where object lenses different in effective diameter are used, the shape of the intervention member 63 is changed matching each object lens without changing the shape of the bobbin, whereby it is made possible to handle different object lenses.

Fifth Embodiment

A pickup apparatus of a fifth embodiment according to the invention will be discussed below with reference to the accompanying drawing.

FIG. 11 is a perspective view of an actuator moving section 70 of the embodiment. The actuator moving section 70 includes an object lens 71, a bobbin 72, an intervention member 73, a pair of tracking coils 74, and a focus coil 75.

The intervention member 73 of the embodiment is an annular member shaped almost like a rectangle on the sectional view and is placed on an iris section 72c in contact with an inner peripheral surface 72b of the bobbin 72 and an upper surface 72e of the iris section 72c projected from the inner peripheral surface 72b. The intervention member 73 is formed of a material having higher thermal conductivity than the resin bobbin 72. The object lens 71 is fixed in contact with the inner peripheral surface 72b of the bobbin 72 and the intervention member 73.

Heat conducted as the tracking coils 74 and the focus coil 75 generate heat is conducted asymmetrically in response to the position of each coil placed on the bobbin 72; some is conducted to the intervention member 73 and some is conducted directly to the object lens 71. The intervention member 73 is formed of a material having higher thermal conductivity than the resin bobbin 72 and thus rapidly conducts the asymmetrically conducted heat in the circumferential direction of the intervention member 73 and conducts the heat uniformly from the perimeter of the object lens 71 to the object lens 71. In the embodiment, some heat is conducted directly to the object lens 71 and therefore the temperature distribution in the object lens 71 becomes asymmetric as compared with the case in the first to fourth embodiments; however, unevenness on the concentric circumference of the temperature distribution occurring in the object lens 71 is remarkably relieved as compared with the case where the intervention member 73 is not used. Thus, degradation of the lens characteristic of the object lens 71 is suppressed and the detection reliability of a detection signal is enhanced. Since the intervention member 73 is simplified in shape as compared with the intervention member 33, 43, 53, 63, the parts costs can be suppressed to low costs.

As described above, according to the first to fifth embodiments according to the invention, the object lens is fixed to the bobbin symmetrically with respect to the optical axis through the intervention member formed of a material having higher thermal conductivity than the bobbin. Particularly, according to the first to fourth embodiments, the object lens and the bobbin are not in direct contact with each other. Therefore, it is made possible to make the circumferential temperature distribution in the object lens 51 almost uniform and it is made possible to suppress degradation of the lens characteristic caused by unevenness of the circumferential temperature distribution.

In the embodiments according to the invention, the specific shapes of the intervention members have been described, but the invention is not limited to them; an intervention member for making it possible to uniformize the circumferential temperature distribution based on the heat from the bobbin and uniformly coming in contact with the object lens in the circumferential direction may be used. For example, in a case where the object lens has a special shape, an arbitrary intervention member adapted to the shape of the object lens may be used.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. An optical pickup apparatus comprising:
an object lens arranged to be opposed to an optical disk;
a bobbin configured to support the object lens; and
an intervention member being interposed between the object lens and the bobbin and is different from the bobbin in thermal conductivity.

2. The optical pickup apparatus as claimed in claim 1, wherein the intervention member is larger in thermal conductivity than the bobbin.

3. The optical pickup apparatus as claimed in claim 1, wherein the bobbin comprises a lens storing hole, and
wherein the intervention member is disposed within the lens storing hole in a manner to be in contact with an inner peripheral surface of the lens storing hole.

4. The optical pickup apparatus as claimed in claim 1, wherein the intervention member comprises a groove formed on a surface thereof where exposed outward.

5. The optical pickup apparatus as claimed in claim 1, wherein the intervention member comprises an iris section configured to narrow incident light transmitted through the object lens.

6. The optical pickup apparatus as claimed in claim 1, wherein the intervention member supports the object lens to be in noncontact with the bobbin.

7. The optical pickup apparatus as claimed in claim 1, further comprising a coil disposed on the bobbin.

8. The optical pickup apparatus as claimed in claim 1, furter comprising:
an elastic member configured to support the bobbin in a suspending manner; and
a fixing section attached to one end of the elastic member.
